(19) United States
(12) Patent Application Publication
(10) Pub. No.: US 2010/0238783 A1
(43) Pub. Date: Sep. 23, 2010

(54) OPTICAL PICKUP

(76) Inventors: Nobuhiro Konuma, Yokohama (JP); Toshio Sugiyama, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/609,277

(22) Filed: Oct. 30, 2009

(30) Foreign Application Priority Data
Mar. 19, 2009 (JP) 2009-068474

(51) Int. Cl. G11B 7/00

(52) U.S. Cl. 369/112.24; G9B/7

(57) ABSTRACT

An optical pickup of this invention includes a first objective lens for a CD or DVD, a second objective lens for a BD, a photodetector, a light source for a CD or DVD, a light source for a BD; a first optical mechanism for guiding first reflected light from the CD or DVD toward the photodetector via the first objective lens, and a second optical mechanism for guiding second reflected light from the BD via the second objective lens and changing the direction of the second reflected light toward the first optical mechanism. After the second reflected light joins a light path of the first reflected light guided by the first optical mechanism, the second reflected light is supplied by the first optical mechanism to the photodetector.

### CROSS-REFERENCE TO RELATED APPLICATIONS

This application relates to and claims priority from Japanese Patent Application No. 2009-68474, filed on Mar. 19, 2009, the entire disclosure of which is incorporated herein by reference.

### TECHNICAL FIELD

The present invention relates to an optical pickup for recording information on optical information recording media such as BDs (Blu-ray Discs), DVDs, and CDs (hereinafter collectively referred to as the “optical disc(s)”) and reproducing the information recorded on the optical discs.

### BACKGROUND ART

Conventionally, optical disc devices capable of recording information on optical discs and reproducing information recorded on the optical discs have been known. This type of optical disc device includes: a spindle motor for rotating an optical disc; an optical pickup for recording information on the optical disc or reproducing the information from the optical disc; and a feed mechanism for moving the optical pickup along a main shaft and a countershaft between the inner circumference of the optical disc and the outer circumference thereof (for example, Japanese Patent Application Laid-Open (Kokai) Publication No. 2006-294134).

However, it is necessary to downsize an optical disc device itself in order to meet the demands for downsizing and reduction in thickness and weight of personal computers, particularly notebook computers.

Also, there is a demand for improvements of an optical pickup along with downsizing of the optical disc device. For example, Japanese Patent Application Laid-Open (Kokai) Publication No. 2006-120306 and Japanese Patent Application Laid-Open (Kokai) Publication No. 2005-327388 disclose that one optical pickup enables information recording on and information reproduction from three types of optical discs, that is, BDs, DVDs, and CDs.

### DISCLOSURE OF THE INVENTION

A return path magnification of a CD/DVD recording/reproduction system is approximately 6 times (6×), while the return path magnification of a BD recording/reproduction system is approximately 20 to 30 times. Even if the distance between a main shaft of an optical pickup and a countershaft thereof can be reduced to a minimum in order to downsize an optical pickup for CDs/DVDs, since the recording/reproduction system for BDs needs to keep a return path length to a certain degree, the distance between the main shaft and the countershaft of an optical pickup for BDs cannot be set in the same manner as the optical pickup for CDs/DVDs.

Accordingly, there has been a limit on downsizing of an optical pickup if information recording on and information reproduction from not only CDs or DVDs, but also BDs are made possible.

Therefore, it is an object of the present invention to provide an optical mechanism that would not obstruct downsizing of an optical pickup even if information recording on and information reproduction from not only CDs or DVDs, but also BDs are made possible.

In order to solve the aforementioned problem, provided according to an aspect of the present invention is an optical pickup including: a first objective lens for a CD or DVD; a second objective lens for a BD; a photodetector; a light source for a CD or DVD; a light source for a BD; a first optical mechanism for guiding first reflected light from the CD or DVD toward the photodetector via the first objective lens; and a second optical mechanism for guiding second reflected light from the BD via the second objective lens and changing the direction of the second reflected light toward the first optical mechanism; wherein after the second reflected light joins a light path of the first reflected light guided by the first optical mechanism, the second reflected light is supplied by the first optical mechanism to the photodetector.

This invention makes it possible not to obstruct downsizing of the optical pickup even if it is made possible to record information on and reproduce information from not only CDs or DVDs, but also BDs.

### BRIEF DESCRIPTION OF THE DRAWINGS

FIG. 1 is a perspective view of an optical disc device equipped with an optical pickup;

FIG. 2 is a perspective enlarged view of the optical pickup;

FIG. 3 is a plan view showing an overview of the internal structure of the optical pickup;

FIG. 4 is a side view showing an overview of an optical mechanism for a CD/DVD;

FIG. 5 is a side view showing an overview of an optical mechanism for a BD;

FIG. 6 is a plan view showing a light-receiving surface pattern of a photodetector;

FIG. 7 is a plan view of the optical pickup showing the outline configuration of the CD/DVD optical mechanism and the BD optical mechanism illustrated in FIGS. 3 to 5;

FIG. 8 is a plan view of an optical pickup according to a first variation;

FIG. 9 is a plan view of an optical pickup according to a second variation;

FIG. 10 is a plan view of an optical pickup according to a third variation; and

FIG. 11 is a plan view of an optical pickup according to a fourth variation.

### BEST MODE FOR CARRYING OUT THE INVENTION

Embodiments of an optical pickup according to the present invention will be explained below. Incidentally, the embodiments described below are for the purpose of describing this invention, but the invention is not limited only to these embodiments. Accordingly, the embodiments described below can be changed in various ways according to the gist of the invention.

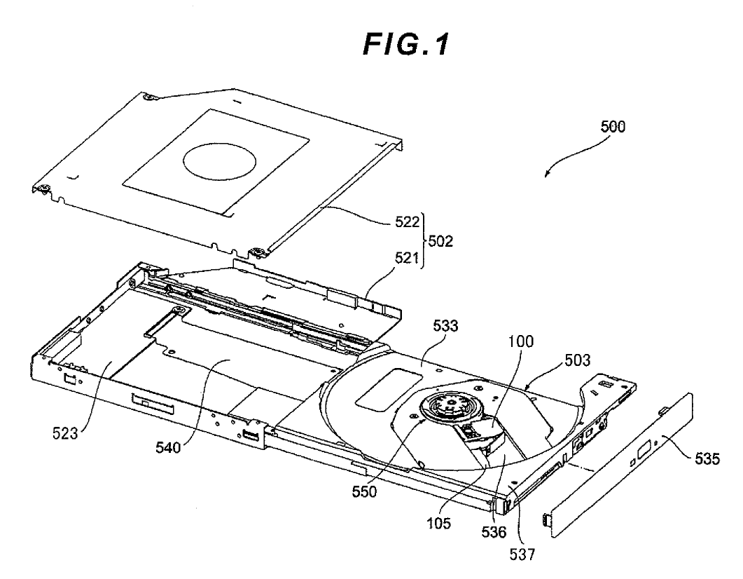

FIG. 1 is a perspective view of an optical disc device having an optical pickup. An optical disc device 500 includes a housing 502 and a tray 503 provided so that it can be inserted into and ejected from the housing 502. The housing 502 is of a box shape composed of a bottom case 521 and a top case 522 placed on the bottom case 521, and is structured so that the tray 503 is inserted into or ejected from an opening in the housing 502.

The bottom case 521 includes a circuit board 523 equipped with an electric circuit having an information processing system and control system for driving the optical disc device 500. This circuit board 523 is connected to an FPC 540. The FPC is connected via a junction circuit (not shown in the drawing) to an FPC 105 for supplying signals to the optical pickup.

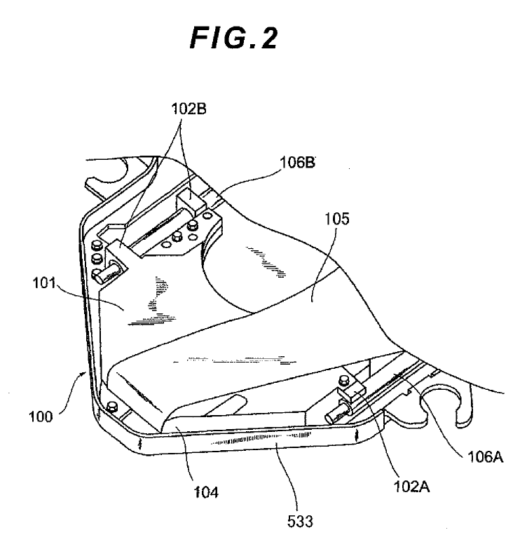

As can be seen in FIG. 2 showing an enlarged view of the optical pickup, the tray 503 (FIG. 1) includes an optical pickup device 100 and two guide rails 106A and 106B (a countershaft 106A and a main shaft 106B) for guiding the movement of the optical pickup 100. The tray 503 is also equipped with a chassis 533 (FIG. 1) on which a spindle motor 550 for rotationally driving the optical disc.

This chassis 533 is of a generally quadrangular shape in planar view. An optical disc is to be mounted on a top surface of the chassis 533 (as shown in FIG. 1) and the chassis 533 has an opening 536 in its top surface, through which part of the optical pickup 100 is exposed.

The two guide rails 106A and 106B are placed in parallel with each other along the direction of insertion/ejection of the tray 503 toward a corner 537, and the optical pickup 100 can move back and forth along these guide rails 106A and 106B in a radial direction of the optical disc. The spindle motor 550 exists at the approximate center of the chassis 533. Reference numeral “535” represents a bezel for closing the opening of the housing 502.

The optical pickup 100 includes a housing 101 for housing a BD optical mechanism, a CD/DVD optical mechanism, a drive mechanism for driving the optical mechanisms, and a circuit board for controlling these mechanisms and receiving and sending signals.

Engagement portions 102A and 102B for engaging with the guide rails 106A and 106B so that they can move along the guide rails 106A and 106B are formed respectively on the side walls of the housing 101 that are in parallel with the movement direction of the housing 101. A side wall 104 of the housing 101 located at its distal end closer to the outside circumference of the optical disc, toward which the housing 101 moves from the center of the optical disc, (that is, the side wall 104 of the housing 101 to be placed opposite the corner 503 of the tray 503 when the optical pickup 100 is attached to the chassis 533 placed on the tray 503) is curved and protrudes with a given radius of curvature (R).

Specifically speaking, the outer surface of the side wall 104 is curved and protrudes towards where the corner 537 is formed, while the insider surface of the side wall 104 is curved and bent inwards, i.e., in the direction opposite the corner 537, so that the inward curve is complementary to the above-described outward curve of the outer surface.

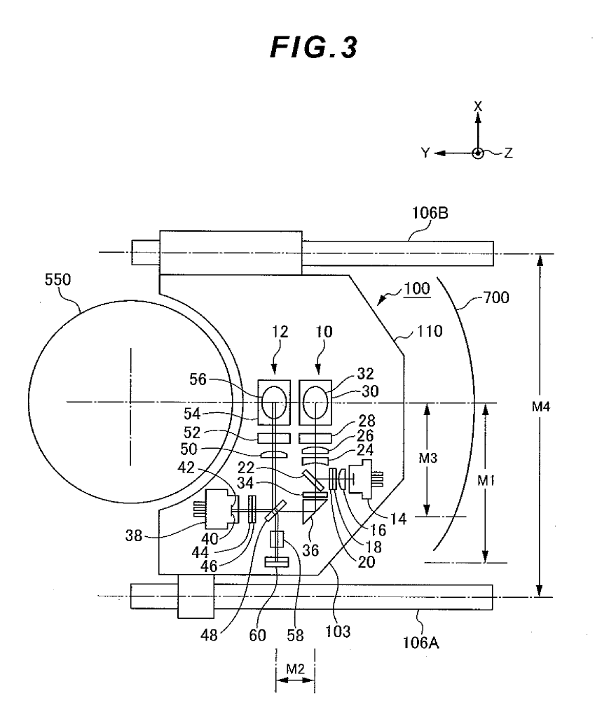

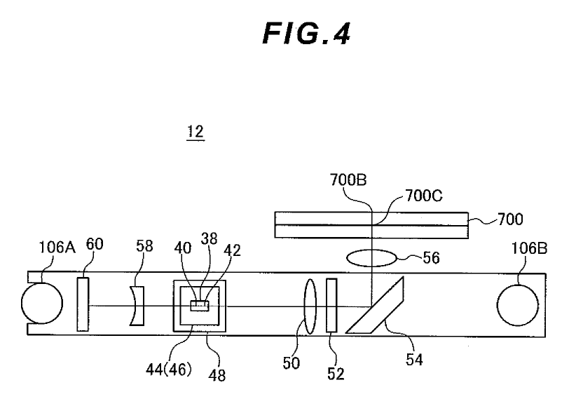

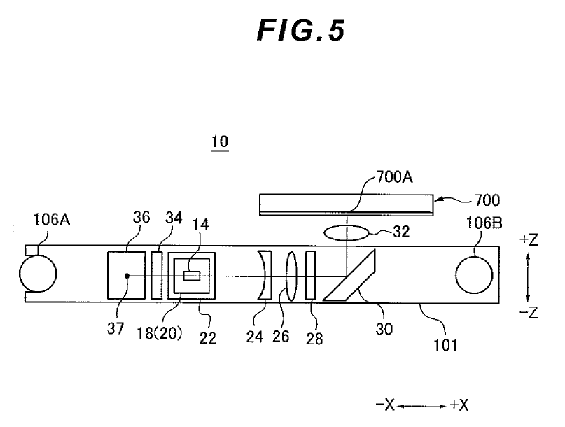

As shown in FIG. 3 which is a plan view showing an overview of the internal structure of the optical pickup, the housing 101 for the optical pickup contains an optical mechanism 10 for recording information on BDs and reproducing information from BDs and an optical mechanism 12 for DVDs and CDs. FIG. 4 is a side view showing an overview of the CD/DVD optical mechanism, and FIG. 5 is a side view showing an overview of the BD optical mechanism.

Directions need to be clarified for explanation of the optical mechanisms. As shown in FIG. 3, X directions (represent a tangential direction of an optical disc 700 and are perpendicular to the lengthwise direction of the main shaft 106B and the countershaft 106A. The X direction that an arrow points is a +X direction, while the opposite X direction is a −X direction. Y directions represent a radial direction of the optical disc (the movement direction of the optical pickup; and the lengthwise direction of the main shaft and the countershaft). The Y direction that an arrow points is a +Y direction representing a direction towards the inner circumference of the optical disc, while the opposite Y direction is a −Y direction representing a direction towards the outer circumference of the optical disc. A direction perpendicular to the surface of the drawing towards the front side of the drawing is a +Z direction, while a direction perpendicular to the surface of the drawing towards the back side of the drawing is a −Z direction.

First, the BD optical mechanism 10 will be explained with reference to FIGS. 3 and 5. The BD optical mechanism has a violet laser light source 14. This violet laser light source 14 emits diverging rays of linearly polarized light (p-polarized light) whose wavelength region is λ₁=405 nm and whose polarization directions are mostly the ±X directions.

The BD optical mechanism includes a lens 16, a half-wave plate 18, a grating 20, and a beam splitter 22, which are placed at a predetermined distance between them in the order listed above starting from the component closest to the violet laser light source as the reference point along the lengthwise direction of the main shaft and the countershaft (+Y direction).

The half-wave plate 18 converts the light beam of the linearly polarized light (p-polarized light) in the ±X directions to polarized light beam (s-polarized light) in the ±Z directions perpendicular to the ±X directions. The three-beam generation grating 20 having no wavelength selectivity is located at the downstream from the half-wave plate 18, and the light beam is diffracted and separated into three light beams, i.e., 0-th order diffraction beam and ±1^{st} order diffraction beams.

Most of the s-polarized light beam which has exited the grating 20 is reflected by the beam splitter 22 in the +X direction. When the reflected light beam passes through the concave lens 24, the luminous flux diameter expands 1.1 to 1.5 times and then reaches a collimate lens 26.

The collimate lens 26 converts the light beam into parallel light. Subsequently, a quarter-wave plate 28 converts the light beam into circularly polarized light, which is then deflected at 90 degrees by a start-up mirror 30 in the +Z direction, that is, towards a recording surface 700A of the BD optical disc 700. Next, the light beam enters a BD objective lens 32 and is thereby made to converge, and then the convergent light is emitted as a light spot onto a track of the BD information recording surface 700A.

When playing a BD, the light beam reflected by the track of the BD information recording surface 700A passes through the objective lens 32 in the −Z direction and becomes a parallel light beam, which is then reflected by the start-up mirror 30 in the -X direction.

Then, the quarter-wave plate 28 converts the light beam into p-polarized light, which then transmits through the collimate lens 26 and thereby becomes a convergent light beam. This convergent light beam passes through the concave lens 24 which converts the light beam into weak convergent light. This weak convergent light totally transmits through the beam splitter 22, and passes through the half-wave plate 34 which converts the light into s-polarized light. Then, the s-polarized light reaches a light path changing optical element (a detection lens element including a cylindrical lens) 36. The light path changing optical element has an internal reflection surface. This reflection surface deflects the light beam at its center 37 in the +Y direction, that is, in the direction along the main shaft 106B.

On the other hand, the CD/DVD optical mechanism 12 shown in FIGS. 3 and 4 has a monolithic double wavelength laser light source 38. A DVD laser light source unit indicated by reference numeral “40” emits a light beam whose wavelength range is λ₂=660 nm. A CD laser light source unit indicated by reference numeral “42” emits a light beam whose wavelength region is λ₃=785 nm.

Once the above-described laser beam is emitted in the −Y direction, it passes through a half-wave plate 44 and a grating 46; and a beam splitter 48 then deflects the light beam at a right angle in the +X direction. After the light beam further passes through a collimate lens 50 and a quarter-wave plate 52, it is reflected by a start-up mirror 54 in the +Z direction. The light beam then enters a CD/DVD objective lens 56 and is thereby made to converge. This convergent light is emitted as a light spot onto a track of a CD information recording surface 700B or a DVD information recording surface 700C.

Next, the light beam reflected by the track of the CD/DVD information recording surface passes through the objective lens 56 in the −Z direction and is deflected by the start-up mirror 54 at 90 degrees in the −X direction. The light beam transmits through the quarter-wave plate 52 and the collimate lens 50 and thereby becomes a convergent light beam. Most of the convergent light beam transmits through the beam splitter 48, further transmits through a detection lens element 58 (such as a cylindrical lens) for causing astigmatism, and then converges on and enters a DVD/CD photodetector 60.

The light path of the CD/DVD-reflected light, which passes through the objective lens 56 and reaches the photodetector 60, is formed in the −X direction. On the other hand, the light reflected by the BD recording surface and deflected in the +Y direction by the reflection surface of the light path changing optical element 36 is then deflected at a right angle in the −X direction by the beam splitter 48 which exists in the light path of the CD/DVD-reflected light; and the deflected light joins the light path of the CD/DVD-reflected and then reaches the photodetector 60. As a result, the photodetector 60 detects not only the CD/DVD-reflected light, but also the BD-reflected light.

The optical path length of the BD-reflected light which is reflected by the BD recording surface, passes through the objective lens 32 and the light path changing optical element 36, joins the CD/DVD-reflected light path, and then reaches the photodetector 60 is longer than the optical path length M1 of the CD/DVD-reflected light which is reflected by the CD/DVD recording surface, passes through the objective lens 56 and the beam splitter 48, and then reaches the photodetector 60, by the length of the light path (M2) from the light path changing optical element 36 to the beam splitter 48; and the optical path length M3 of the BD-reflected light in the X direction is shorter than the optical path length M1 of the CD/DVD-reflected light in the X direction. Therefore, even if the optical mechanism for information recording on BDs and information reproduction from BDs is applied to an optical pickup, the BD optical pickup can be placed in the size M4 (distance between the main shaft and the countershaft) of the CD/DVD optical pickup.

Both the CD/DVD optical mechanism and the BD optical mechanism are formed in the X direction, but the CD/DVD optical mechanism is formed off to the side of the BD optical mechanism in the +Y direction. The casing 101 for the optical pickup has a tapered shape 103. This area may obstruct the placement of the BD optical mechanism. However, since the reflected light from a BD is deflected by the light path changing optical element in the +Y direction, it can reach the photodetector 60 without being limited by the tapered area 103.

The CD/DVD objective lens 56 and the BD objective lens 32 are placed in parallel with each other in the Y direction. Since the light path of the reflected light from a CD/DVD is located closer to the center of the optical disc 700 than the light path of the reflected light from a BD is, the CD/DVD objective lens 56 is located closer to the inner circumference of the optical disc than the BD objective lens 32 is.

This is advantageous to, for example, a LightScribe-enabled drive. LightScribe draws information on a disc label surface, using a CD/DVD laser beam. Since a control signal for LightScribe exists at a position closer to the center of the disc than the innermost circumference of the disc is, the CD/DVD objective lens has the advantage of being located closer to the inner circumference of the disc.

The CD/DVD objective lens 56 and the BD objective lens 32 are driven to make translational movements in the ±Z directions (focus action by applying electric current to a focus drive coil (not shown in the drawing), and are driven to make translational movements in the ±Y directions (tracking action) by applying electric current to a tracking drive coil (not shown in the drawing), and are driven to rotate around the X axis as seen in the drawing (tilt action) by applying electric current to a tilt drive coil (not shown in the drawing).

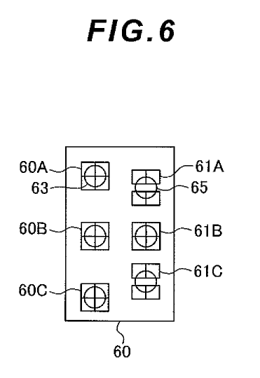

Incidentally, FIG. 6 is a plan view of a light-receiving surface pattern of the photodetector 60. The light-receiving surface is constituted from four-sectioned light-receiving areas 60A, 60B, 60C for receiving CD light beam spots 63, and four-sectioned light-receiving areas 61A, 61B, 61C for receiving DVD/BD light beam spots 65. The optical pickup can detect a tracking error signal by a three-beam method, using the four-sectioned light-receiving areas of the photodetector.

In the above-described embodiment, the dark line width of the four-sectioned light-receiving areas 61A, 61C which sub-spots in the DVD/BD light beam enter is increased. A double-layer disc has a problem of fluctuation of a push-pull signal due to incoming of unnecessary light from another layer to the sub-spots, but increase in the dark line width has the effect of reducing the fluctuation. Incidentally, since CDs are made of single-layer discs only, the dark line width of the four-sectioned light-receiving areas 60A, 60C which sub-spots in the CD light beam enter is not increased.

In this embodiment, a flat plate mirror is used as the beam splitter 22 and the beam splitter 48. When the convergent light transmits through an inclined flat plate mirror, astigmatism occurs. So, the detection lens element 58 is first optically designed so that an astigmatism component within a focus detection range of approximately 4 to 6 μm which is ideal for CDs or DVDs will be synthesized from an astigmatism component generated by the beam splitter 48 and an astigmatism component generated by the detection lens element 58. Next, the light path changing optical element 36 is optically designed so that an astigmatism component within a focus detection range of approximately 1 to 2 μm which is ideal for BDs will be synthesized from an astigmatism component generated by the beam splitter 22, an astigmatism component generated by the light path changing optical element (or cylindrical lens) 36, and an astigmatism component generated by the detection lens element 58. As a result, the above process enables focus detection by the astigmatism method.

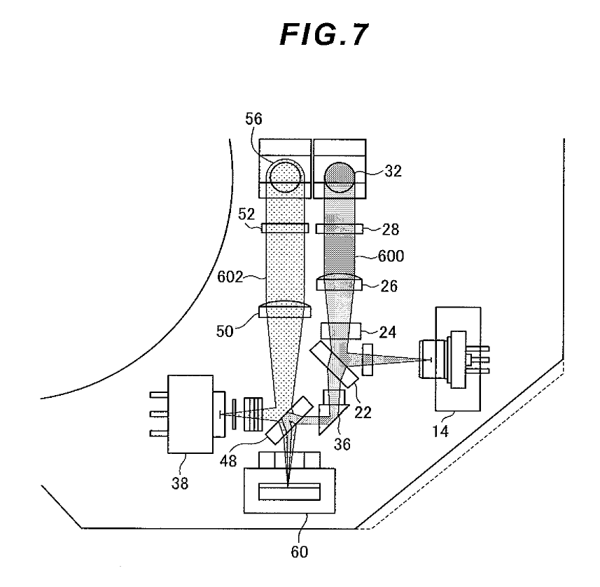

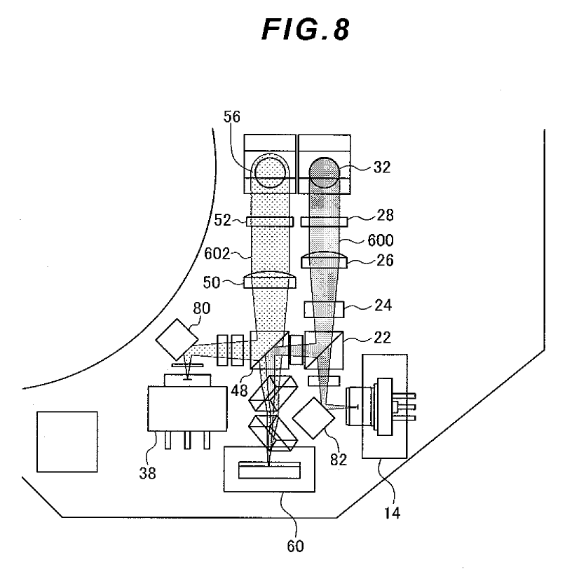

Next, variations of the CD/DVD optical mechanism 12 and the BD optical mechanism 10, which have been explained above with reference to FIGS. 3 to 5, will be explained schematically with reference to FIGS. 7 to 11. Incidentally, FIG. 7 is a schematic diagram showing the configuration of FIG. 3 and may be referred to in order to understand variations shown in FIGS. 8 to 11. In FIGS. 7 to 11, reference numeral “600” represents the light path of reflected light from a BD, while reference numeral “602” represents the light path of reflected light from a CD/DVD. Since FIGS. 7 to 11 are schematic diagrams showing variations, not all the components of the optical mechanisms in FIG. 3 are necessarily shown in those diagrams. Also, the variations shown in FIGS. 7 to 11 may include components other than those of the optical mechanisms shown in FIG. 3.

FIG. 8 shows that a light beam from the BD light source 14 is reflected by a mirror 82 and is made to enter the beam splitter 22 from the +Y direction. The BD-reflected light 600 is deflected at a right angle by the beam splitter 22 toward the light path 602 of the CD/DVD-reflected light and joins the beam splitter 48 in the CD/DVD-reflected light path. Also, a light beam is emitted from the CD/DVD light source 38 in the +Y direction, is reflected by a mirror 80 in the −X direction, and then enters the beam splitter 48. Since this embodiment does not need the light path changing optical element (indicated by reference numeral “36” in FIG. 7), the length of the reflected light path in the Y direction can be reduced; however, since the mirrors 80, 82 are needed in this embodiment, there is a disadvantage in laying out the light sources 14, 38 and the mirrors 80, 82.

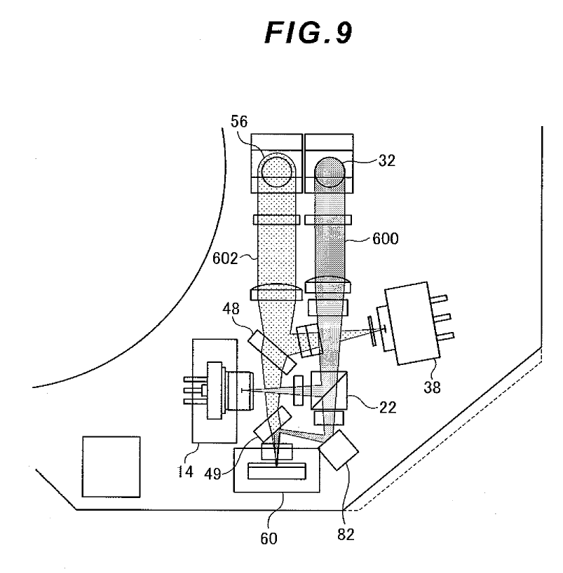

The difference between the configuration shown in FIG. 9 and that in FIG. 7 is that the position of the BD light source 14 is changed to that of the CD/DVD light source 38 and vice versa so that they are located at opposite positions from those shown in FIG. 7. Specifically speaking, FIG. 9 shows that the BD light source 14 is placed on the CD/DVD-reflected light path 602 side, while the CD/DVD light source 38 is placed on the BD-reflected light path 600 side. The positions of the two light sources may be exchanged as described above. Incidentally, reference numeral “49” represents a beam splitter.

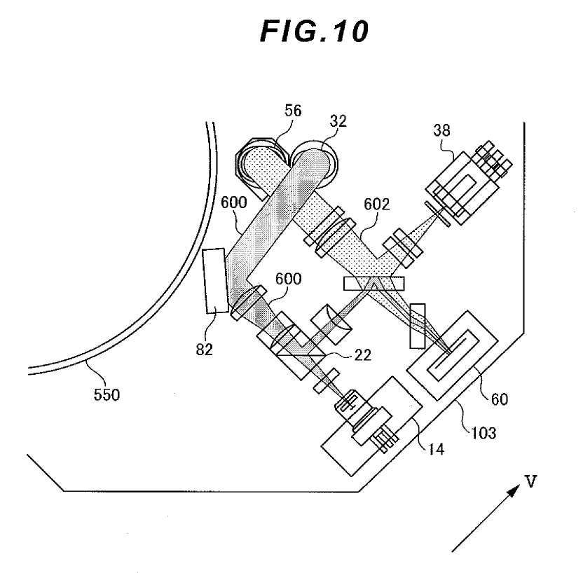

FIG. 10 shows an embodiment in which the layout of the photodetector 60 is decided using the tapered surface 103. The photodetector 60 is positioned by the tapered surface 103. The BD-reflected light path 600 and the CD/DVD-reflected light path 602 are formed perpendicularly to the tapered surface 103. The CD/DVD-reflected light path 602 is offset from the BD-reflected light path 600 in a V-direction (at an acute angle) in order to avoid the outer circumference of the spindle motor 550 and obtain the longer optical path length of the CD/DVD-reflected light path 602. As a result, the BD light source 14 can be placed along the tapered surface 103. The light beam ejected from the light source 14 is deflected by the mirror 82 and is guided across the CD/DVD-reflected light path 602 toward the BD objective lens 32.

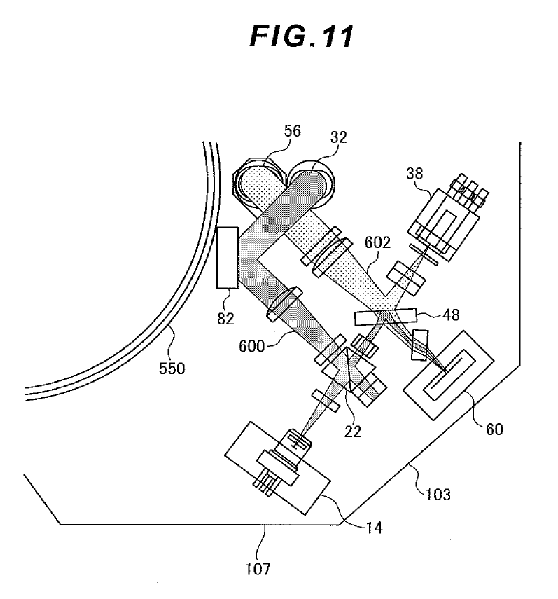

The difference between the configuration shown in FIG. 11 and that in FIG. 9 is that the BD light source 14 is placed, not beside the tapered surface 103, but beside the side wall 107 on the countershaft 106A side of the casing 101 for the optical pickup. Incidentally, each of the variations shown in FIGS. 8 to 11 is configured so that the BD-reflected light joins the light path of the CD/DVD-reflected light and is then detected by the detector positioned in the light path of the CD/DVD-reflected light. As a result, the return path optical magnification of the BD optical mechanism can be increased in the same manner as in the embodiment shown in FIGS. 3 to 7.

### INDUSTRIAL APPLICABILITY

The optical pickup according to the present invention contributes to downsizing of optical disc devices. As a result, the optical disc device equipped with the optical pickup according to this invention is ideal for use in small information devices such as small notebook personal computers. Since the optical pickup according to the invention can increase a return path optical magnification of light reflected from a BD, the optical pickup can be applied to BD multilayer discs.

What is claimed is:

1. An optical pickup comprising:
a first objective lens for a CD or DVD;
a second objective lens for a BD;
a photodetector;
a light source for a CD or DVD;
a light source for a BD;
a first optical mechanism for guiding first reflected light from the CD or DVD toward the photodetector via the first objective lens; and
a second optical mechanism for guiding second reflected light from the BD via the second objective lens and changing the direction of the second reflected light toward the first optical mechanism;
wherein after the second reflected light joins a light path of the first reflected light guided by the first optical mechanism, the second reflected light is supplied by the first optical mechanism to the photodetector.

2. The optical pickup according to claim 1, wherein the first objective lens and the second objective lens are placed along a radius of an optical disc that is at least one of the CD, the DVD, and the BD.

3. The optical pickup according to claim 2, wherein the first objective lens exists at a position closer to the inner circumference of the optical disc.

4. The optical pickup according to claim 2, wherein the first optical mechanism and the second optical mechanism form the light path of the first reflected light and a light path of the second reflected light in parallel with one another along a tangential direction of the optical disc, and the light path of the first reflected light is formed at a position closer to the inner circumference of the optical disc.

5. The optical pickup according to claim 1, wherein the second optical mechanism forms a light path of the second reflected light so that a return path optical magnification of the second reflected light exceeds a return path optical magnification of the first reflected light.

6. The optical pickup according to claim 1, wherein after the second optical mechanism makes a light path of the second reflected light intersect with the light path of the first reflected light, it makes the second reflected light join the light path of the first reflected light.

7. The optical pickup according to claim 1, wherein the first optical mechanism includes a first beam splitter that is a plane-parallel plate mirror causing astigmatism, and a first detection lens element causing astigmatism;
wherein the second optical mechanism includes a second beam splitter that is a plane-parallel plate mirror causing astigmatism, and a second detection lens element causing astigmatism; and
wherein focus detection of all the CD, DVD, and BD is performed by means of an astigmatic method.
